(19) United States
(12) Patent Application Publication
(10) Pub. No.: US 2026/0200402 A1
(43) Pub. Date: Jul. 16, 2026

(54) REMOVABLE, CUSTOMIZABLE, SOLID STEP COVERS FOR A RECREATIONAL VEHICLE (RV) AND METHODS OF MAKING AND USING SAME

(71) Applicant: Mark J. Gorrie, Nazareth, PA (US)

(72) Inventor: Mark J. Gorrie, Nazareth, PA (US)

(21) Appl. No.: 19/447,344

(22) Filed: Jan. 13, 2026

Related U.S. Application Data
(60) Provisional application No. 63/745,269, filed on Jan. 14, 2025.

(51) Int. Cl. B60R 3/00

(52) U.S. Cl. CPC B60R 3/00

(57) ABSTRACT

Systems, methods, and other embodiments for removable, customizable recreational vehicle (RV) step covers. The step covers are a novel, easy-to- install/remove, customizable step cover that can be attached over an existing step on a RV. The step covers can be easily cleaned, are skid resistant, and can be customized to match the color of the RV.

### CROSS-REFERENCE TO RELATED APPLICATION

This application claims benefit of U.S. Patent Application 63/745,269, filed on January 14, 2025, the disclosure of which is hereby incorporated by reference in its entirety to provide continuity of disclosure to the extent such a disclosure is not inconsistent with the disclosure herein.

### FIELD OF THE INVENTION

The present invention is generally related to removable, customizable recreational vehicle (RV) step covers. The step covers are a novel, easy-to- install/remove, customizable step cover that can be attached over an existing step on a RV. The step covers can be easily cleaned, are skid resistant, and can be customized to match the color of the RV. Furthermore, the step covers may include a glow in the dark strip for added safety.

### BACKGROUND OF THE INVENTION

Prior to the present invention, as set forth in general terms above and more specifically below, it is known in the motor vehicle art, especially the recreational vehicle (RV) art, that the current RV step covers are flimsy, hard to install, and difficult to clean before the step is flipped back up into the RV. For example, in many instances, the steps are flipped back up into the RV in a wet and dirty condition because the existing step covers cannot be adequately cleaned. This can create a driving hazard in that the debris on the steps/step covers may fly off while the RV is traveling down the road. Therefore, it would be desired if the steps could be kept clean prior to being flipped back into the RV.

It is also known that traditional step covers wear out fast, especially with regular exposure to the elements. Also, these traditional step covers can become slippery when wet which could lead to dangerous slips and falls. Therefore, it would be further desired if the steps were constructed of a durable material and were skid resistant.

It is a purpose of this invention to fulfill these and other needs in the RV step art in a manner more apparent to the skilled artisan once given the following disclosure.

The preferred recreational vehicle (RV) step cover, according to various embodiments of the present invention, offers the following advantages: ease of use; durability; the ability to quickly and easily attach/remove the step cover; the ability to customize the step cover; ease of cleaning; skid resistance; and improved safety. In fact, in many of the preferred embodiments, these advantages are optimized to an extent that is considerably higher than heretofore achieved in prior, known RV step covers.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is an isometric, schematic illustration of a removable, customizable recreational vehicle (RV) step cover, constructed according the present invention;

FIG. 2 is an isometric, schematic illustration of the removable, customizable recreational vehicle (RV) step cover prior to being installed on an existing RV step, constructed according the present invention;

FIG. 3 is an isometric, schematic illustration of the removable, customizable recreational vehicle (RV) step cover being initially installed on an existing RV step, constructed according the present invention;

FIG. 4 is an isometric, schematic illustration of the removable, customizable recreational vehicle (RV) step cover being completely installed on an existing RV step, constructed according the present invention; and

FIG. 5 is an isometric, schematic illustration of a plurality of removable, customizable recreational vehicle (RV) step covers being completely installed on existing RV steps, constructed according the present invention.

### DETAILED DESCRIPTION OF THE PREFERRED EMBODIMENTS OF THE INVENTION

In order to address the shortcomings of the prior, known recreational vehicle (RV) step covers, it would be desirable to utilize a novel, easy-to- install/remove, customizable step cover that can be attached over a step on an RV. Also, it would be desired if the step covers can be easily cleaned, a skid resistant, and can be customized to match the color of the RV. Finally, it would be desired if the step covers could include a glow in the dark strip for added safety.

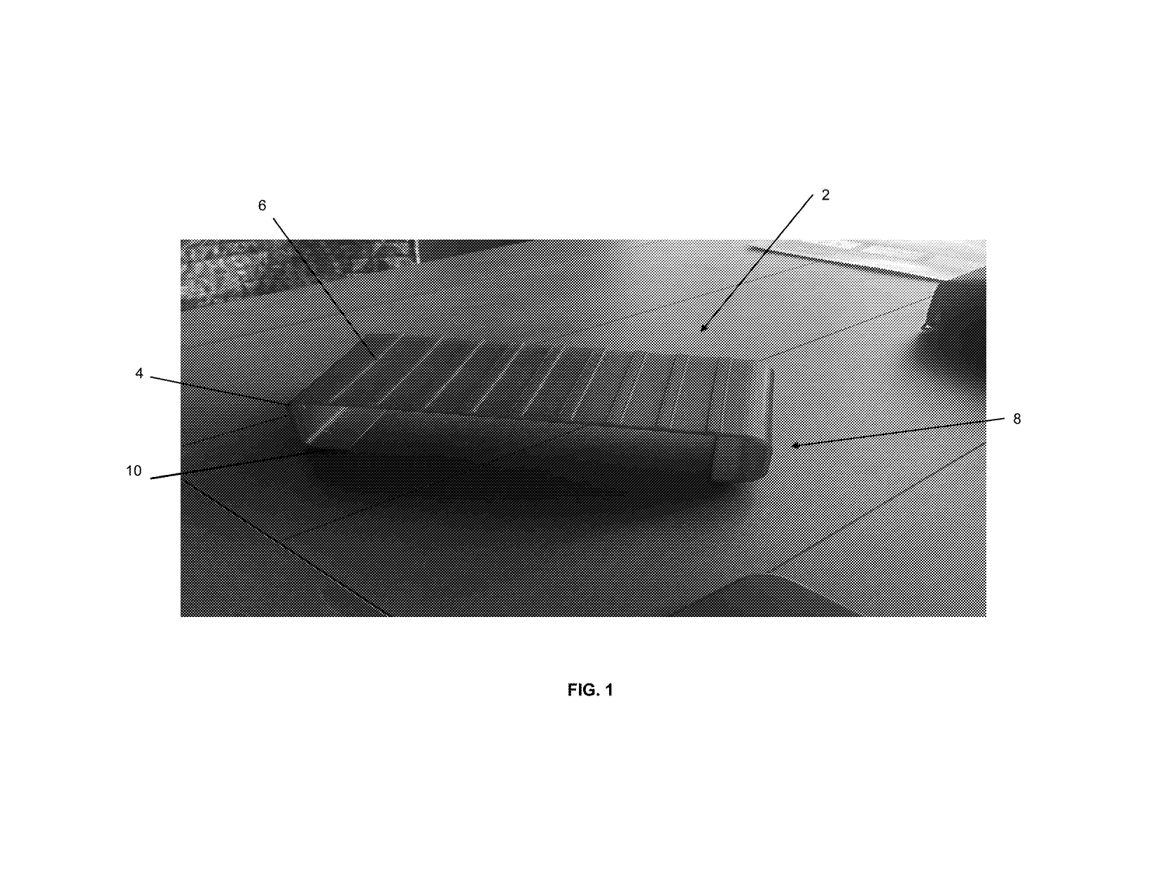

Reference is made now to FIG. 1, where there is illustrated a removable, customizable recreational vehicle (RV) step cover assembly 2, wherein the step cover assembly 2 includes, in part, step cover 4, raised areas 6, step cover sides 8, and step cover bottoms 10. Preferably, step cover assembly 2 is constructed of any suitable, durable, high strength, UV resistant, and lightweight thermoplastic elastomeric (TPE) material. It is to be understood that step cover assembly 2 can be constructed of any material that will allow a color of the step cover assembly 2 to be customized. Finally, step cover assembly 2 can be conventionally formed through the use of printing, forming, extruding, cutting, casting, or the like.

### Using the Step Cover Assembly 2

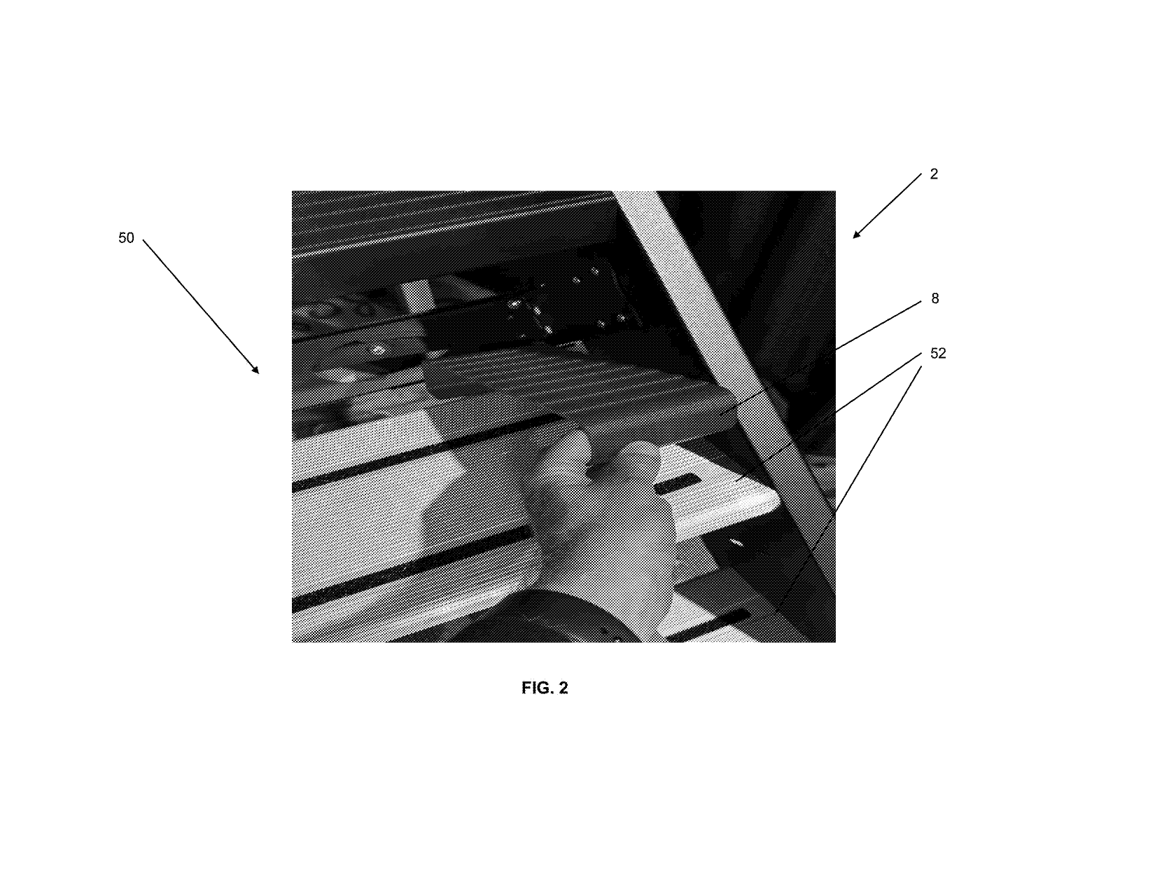

In order to use step cover assembly 2, attention is directed to FIGS. 1-5. In particular, after the customized color of the step cover assembly 2 has been determined and the step cover assembly 2 is constructed, the user selects an existing step 52 from the recreational vehicle step assembly 50 on which the step cover assembly 2 is to be located. As shown in FIG. 2, the step cover assembly 2 is located over an existing step 52 so that one step cover side 8 is located over an edge of the step 52 and the step cover bottom 10 is located under the step 52.

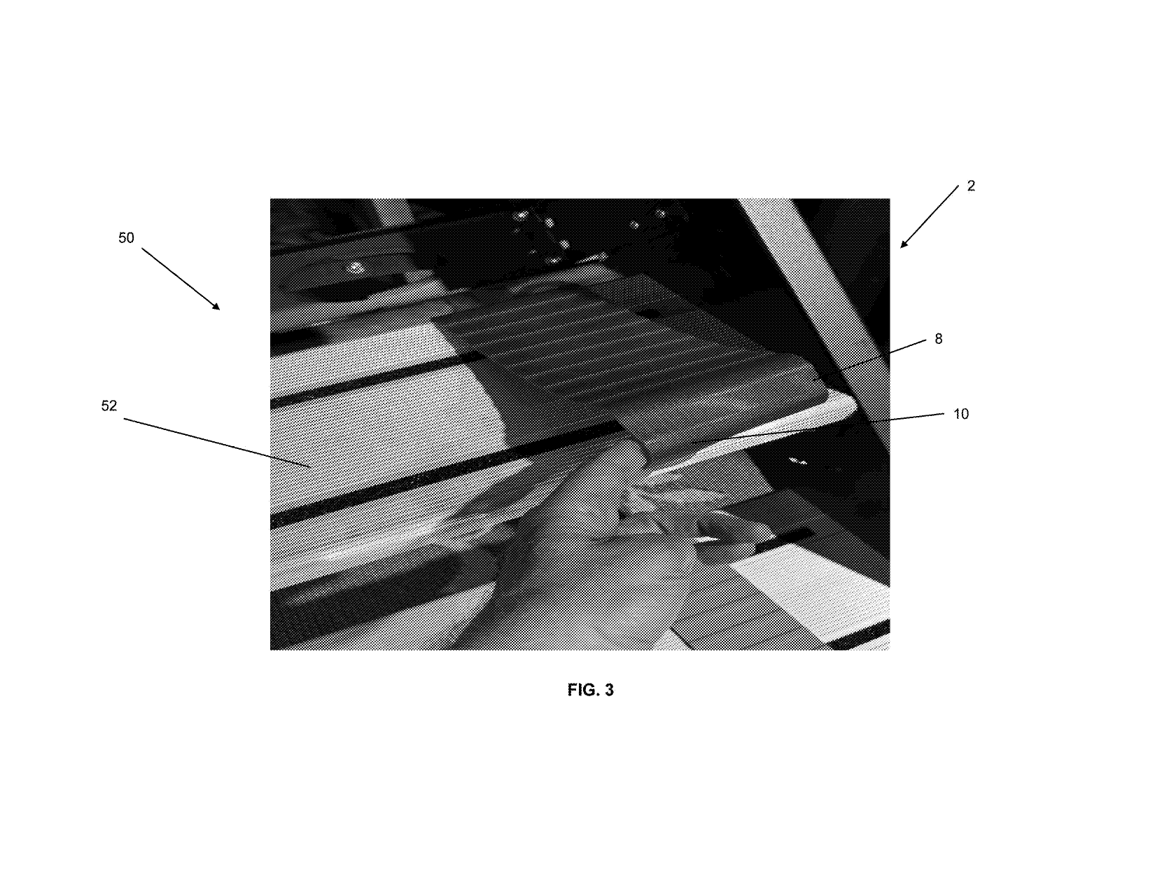

As shown in FIG. 3, the other step cover side 8 is then slightly pulled so that the step cover 4 bends so that the other step cover side 8 and the other step cover bottom 10 can be located over the other edge of the step 52.

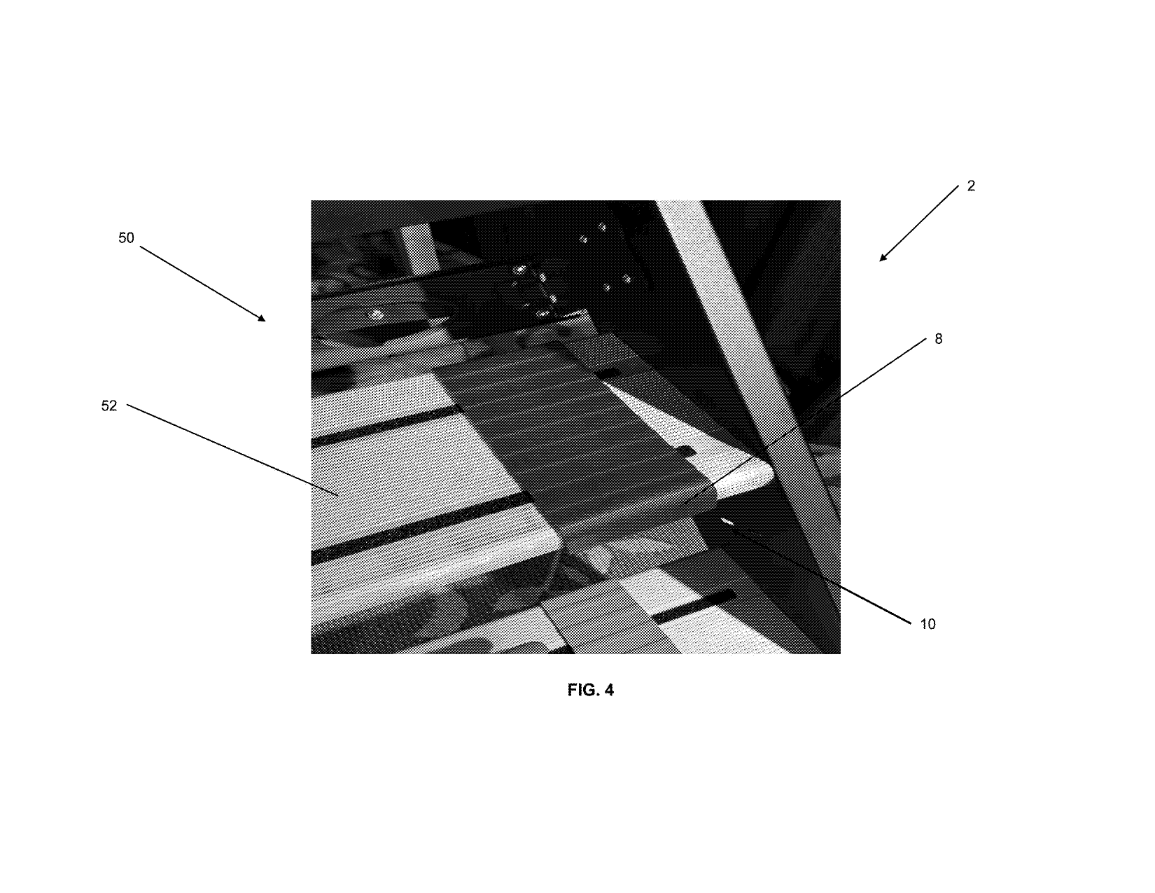

With respect to FIG. 4, the other step cover side 8 has been located over the other edge of the step 52 and the other step cover bottom 10 is now located under the other edge of the step 52. In this manner, the step cover assembly 2 is now securely retained on the step 52.

In order to remove the step cover assembly 2 from the existing step 52, the use simply pulls on the one step cover side 8 so that the step cover bottom 10 is no longer located under the edge of the step 52.

The user then pulls up on the step cover assembly 2 and slides the step cover assembly 2 so that the other end of the step cover assembly 2 is moved away from the other edge of the step 52. The user can then simply lift up the step cover assembly 2 to remove it from the existing step 52.

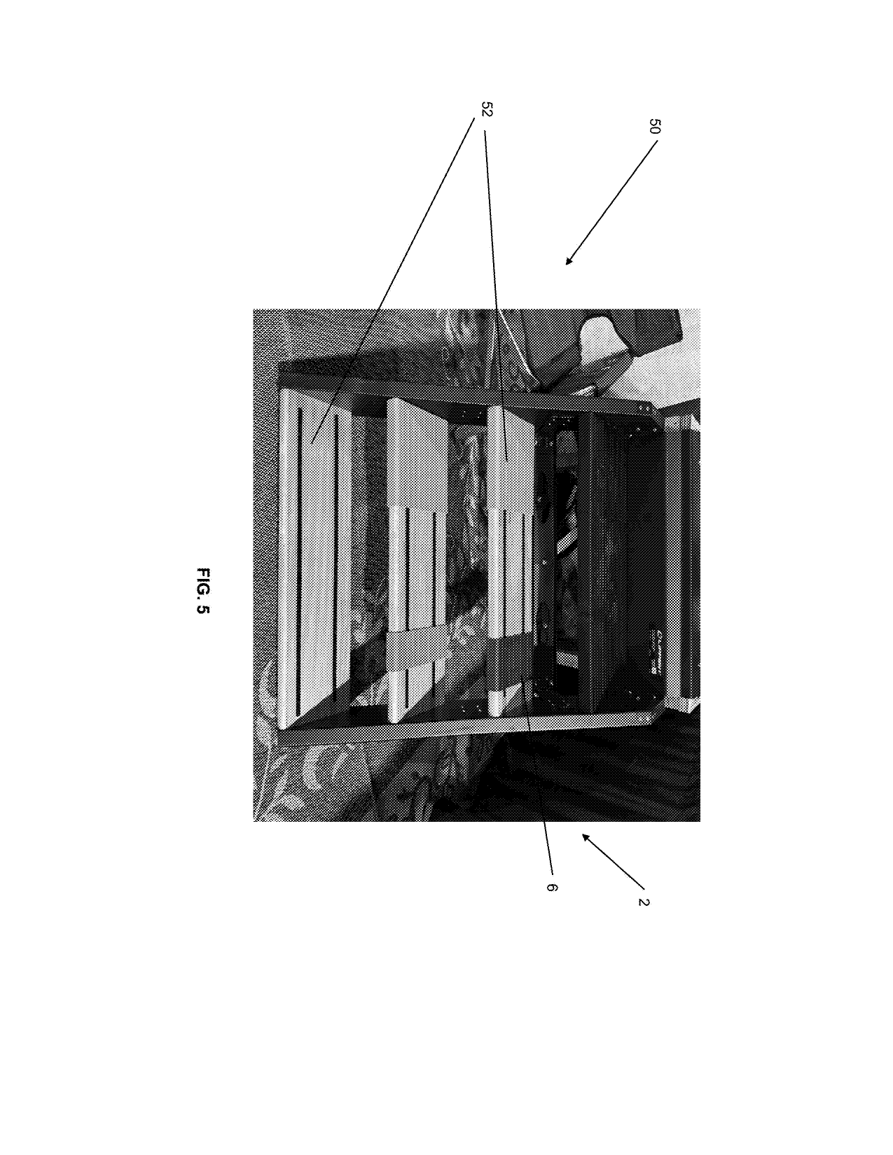

A unique aspect of the present invention is the customization of the step cover assembly 2. As shown in FIG. 5, the step cover assembly 2 can be constructed in a red color that makes the step cover assembly 2 easily visible for safety reasons. Also, the step cover assembly 2 could also be constructed in a color that matches the color of the existing steps 52, the RV, or any other desired color.

Another unique aspect of the present invention is that the step cover assembly 2 can include a glow in the dark strip (not shown) for safety reasons.

Another unique aspect of the present invention is the use of raised areas 6 on the step cover assembly 2. In particular, the raised areas 6 are located on the surface of the step cover assembly 2 in order to provide a skid resistant surface. It is to be understood that while the raised areas 6 are depicted as being raised, flat areas, the shape of the raised areas 6 can include other geometric shapes as long as the geometric shape provides the necessary non-skid surface.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as "lower," "upper," "horizontal," "vertical," "above," "below," "up," "down," "top" and "bottom" as well as derivatives thereof (e.g., "horizontally," "downwardly," "upwardly," etc.) should be construed to refer to the orientation as then described or as shown in the drawing under discussion. These relative terms are for convenience of description and do not require that the apparatus be constructed or operated in a particular orientation. Terms concerning attachments, coupling and the like, such as "connected" and "interconnected," refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety.

The applicant reserves the right to physically incorporate into this specification any and all materials and information from any such patents, publications, scientific articles, web sites, electronically available information, and other referenced materials or documents to the extent such incorporated materials and information are not inconsistent with the description herein.

All of the features disclosed in this specification may be combined in any combination. Thus, unless expressly stated otherwise, each feature disclosed is only an example of a generic series of equivalent or similar features.

The specific methods and compositions described herein are representative of preferred embodiments and are exemplary and not intended as limitations on the scope of the invention. Other objects, aspects, and embodiments will occur to those skilled in the art upon consideration of this specification and are encompassed within the spirit of the invention. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms "comprising", "including", "containing", etc. are to be read expansively and without limitation. The methods and processes illustratively described herein suitably may be practiced in differing orders of steps, and that they are not necessarily restricted to the orders of steps indicated herein.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other modifications and implementations will occur to those skilled in the art without departing from the spirit and the scope of the invention. Accordingly, the description hereinabove is not intended to limit the invention.

Therefore, provided herein is a new and improved recreational vehicle (RV) step cover, which according to various embodiments of the present invention, offers the following advantages: ease of use; durability; the ability to quickly and easily attach/remove the step cover; the ability to customize the step cover; ease of cleaning; skid resistance; and improved safety. In fact, in many of the preferred embodiments, these advantages are optimized to an extent that is considerably higher than heretofore achieved in prior, known RV step covers.

What is claimed is:

1. A step cover assembly for use with recreational vehicle steps, wherein the step cover assembly is comprised of:a step cover;a plurality of raised areas located on a top side of the step cover;a first and a second step cover side, wherein the first step cover side is connected at one end to one end of the step cover and the second step cover side is connected at one end to another end of the step cover; anda first and a second step cover bottom, wherein the first step cover bottom is connected to the other end of the first step cover side and the second step cover bottom is connected to the other end of the second step cover side.

2. The step cover assembly, according to claim 1, wherein the step cover assembly is constructed of a durable, high strength, UV resistant, and lightweight thermoplastic elastomeric (TPE) material and wherein the material is capable of being colored.

3. The step cover assembly, according to claim 2, wherein the step cover assembly is constructed by printing, forming, extruding, cutting, casting, or the like.

4. A method of constructing a step cover assembly for use with recreational vehicle steps, wherein the step cover assembly is comprised of:providing a step cover;locating a plurality of raised areas on a top side of the step cover;providing a first and a second step cover side, wherein the first step cover side is connected at one end to one end of the step cover and the second step cover side is connected at one end to another end of the step cover; anda first and a second step cover bottom, wherein the first step cover bottom is connected to the other end of the first step cover side and the second step cover bottom
is connected to the other end of the second step cover side.

5. The method, according to claim 4, wherein the step cover assembly is constructed of a durable, high strength, UV resistant, and lightweight thermoplastic elastomeric (TPE) material and wherein the material is capable of being colored.

6. The method, according to claim 5, wherein the step cover assembly is constructed by printing, forming, extruding, cutting, casting, or the like.

7. A method of using a step cover assembly for use with recreational vehicle steps, wherein the step cover assembly is comprised of:providing a step cover;locating a plurality of raised areas located on a top side of the step cover;providing a first and a second step cover side, wherein the first step cover side is connected at one end to one end of the step cover and the second step cover side is connected at one end to another end of the step cover;providing a first and a second step cover bottom, wherein the first step cover bottom is connected to the other end of the first step cover side and the second step cover bottom is connected to the other end of the second step cover side;selecting an existing step from a recreational vehicle step assembly on which the step cover assembly is to be located;locating the step cover assembly over the existing step, wherein the first step cover side is located over an edge of the existing step and first step cover bottom is located under the existing step;pulling on the second step cover side, wherein the step cover bends so that the second step cover side and the second step cover bottom are configured to be located over another edge of the existing step, and wherein the step cover assembly is then
securely retained on the existing step.

8. The step cover assembly, according to claim 7, wherein the step cover assembly is constructed of a durable, high strength, UV resistant, and lightweight thermoplastic elastomeric (TPE) material and wherein the material is capable of being colored.

9. The step cover assembly, according to claim 8, wherein the step cover assembly is constructed by printing, forming, extruding, cutting, casting, or the like.
